(19) United States
(12) Patent Application Publication
(10) Pub. No.: US 2009/0092473 A1
(43) Pub. Date: Apr. 9, 2009

(54) Method of stacking firewood

(76) Inventor: Mark Bedard, St. Lambert (CA)

Correspondence Address: Eric Fincham, 316 chemin Knowlton, Lac Brome, QC, J0E 1VO, CA

(21) Appl. No.: 12/284,173

(22) Filed: Sep. 19, 2008

(30) Foreign Application Priority Data
Sep. 19, 2007 (CA) 2,602,998

(51) Int. Cl. B65G 57/00

(52) U.S. Cl. 414/788.9; 414/802

(57) ABSTRACT

A method for stacking firewood which comprises the steps of supplying an elongated strap, securing a first end portion of the strap about a piece of firewood, laying a first portion of the strap along a substrate, placing a plurality of logs in a side by side relationship to form a first row on top of the first portion of the strap, wrapping the strap about an end of the first row and then extending the strap on top of the first row, stacking further objects in a second row on top of the strap and first row, and wrapping the strap about a second end of the second row and again extending the strap on top of the second row. The steps are repeated until the desired amount of firewood is stacked.

### FIELD OF THE INVENTION

The present invention relates to a method for stacking objects and more particularly, to a method for stacking firewood.

### BACKGROUND OF THE INVENTION

Fireplaces are widely used in many residences. A fireplace may be utilized only for aesthetic purposes or, in colder climates, used for heating.

Although there are many different types of fireplaces and fuels therefore, wood burning fireplaces have, to many people, the greatest appeal. As will be appreciated, continuous use of the fireplace can require substantial quantities of firewood. Usually, the firewood consists of logs or log portions. Storage of the wood is accomplished by stacking of the logs and log portions in a plurality of rows on top of each other.

In order to provide for proper stacking, many people use a pair of uprights to prevent the firewood from being displaced by pieces of wood falling at the ends. Many such manufactured uprights are commercially available and while they are perfectly functional, their appearance and size is sometimes considered undesirable.

Other indoor stacking devices can only contain a very limited amount of firewood; such stacking devices include, for example, canvas carriers and the like.

One method of stacking firewood when supports are not available is the use of half logs aligned in alternating directions at the ends of the wood pile. This arrangement operates well if the desired half logs are available and are of the correct size. However, such stacking requires a certain amount of skill on the part of the person doing the stacking and generally, inexperienced people are unable to stack the firewood in this manner in a stable fashion.

### SUMMARY OF THE INVENTION

It is an object of the present invention to provide a method for stacking firewood and which method is suitable for inexperienced stackers.

It is a further object of the present invention to provide a method and device for stacking firewood wherein the device will maintain the stacked firewood in a manner to have an aesthetically pleasing appearance.

According to one aspect of the present invention, there is provided a method for stacking a plurality of objects comprising the steps of supplying an elongated strap having first and second end portions, securing the first end portion about a first one of the objects, laying a first portion of the strap along a substrate, placing a plurality of the objects in a side by side relationship to form a first row, wrapping the strap about an end of the row on top of the first row, stacking further objects in a second row on top of the strap placed on the first row, and wrapping the strap about a second row end object and on top of the second row.

According to a further aspect of the present invention there is provided a stacked pile of firewood comprising a plurality of rows of stacked firewood, each row having a first and a second end piece, a strap extending from a first end piece of a bottom row under the bottom row and subsequently partially around a second end piece of the bottom row, the strap subsequently extending on top of the second row and partially around a first end piece of a second row, the strap extending back and forth between each row and around end pieces.

The method of the present invention is primarily directed to maintaining firewood in a stack. However, it will be understood that any similar object may likewise employ the method of the present invention. The method is highly advantageous for objects of a cylindrical nature.

An advantage of the present invention is that it may be applied to many different sizes of both the object being stacked and the total size of the stacked objects. The only requirement is that there be a continuous strap; this may be achieved by a strap formed as a single piece or alternatively by a plurality of straps suitably joined together.

The strap may have varying widths depending upon the objects being stacked, and in the case of firewood, a strap in the range of a strap having a width of between 2″ and 8″ is preferred and even more preferably, the strap will have a width of between 3″ and 5″.

As aforementioned, the total length will depend upon the amount of firewood being stacked; generally, a length of between 6′ and 50′ has been found to be suitable and even more preferably, a length of between 10′ and 30′ may be utilized. As aforementioned, pieces may be joined together to form a longer strap and many different types of mechanical fasteners may be utilized. The use of a hook and loop fastener such as sold under the trademark “VELCRO” may be employed.

The material of the strap may be any suitable and in one preferred embodiment, may be of a woven plastic material.

As used herein, a strap means any elongated piece of material suitable for the purpose. Preferably, the strap is wrapped around a spool.

### BRIEF DESCRIPTION OF THE DRAWINGS

Having thus generally described the invention, reference will be made to the accompanying drawings illustrating an embodiment thereof, in which:

FIG. 1 is a perspective view of a device used in the stacking of firewood;

FIG. 2 is a side elevational view of firewood stacked using the device of the present invention; and

FIG. 3 is an end elevational view thereof.

### DETAILED DESCRIPTION OF THE INVENTION

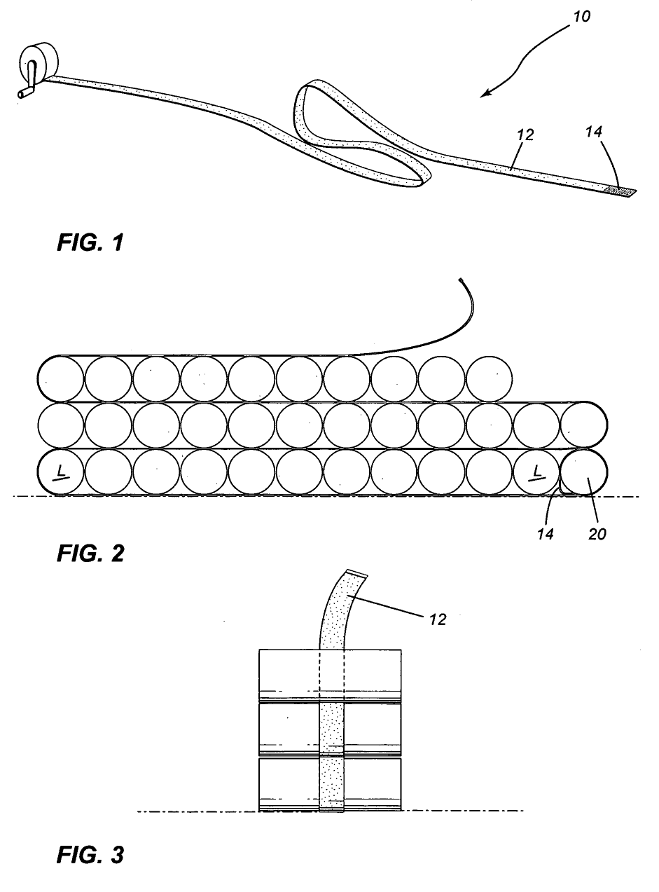

Referring to the drawings in greater detail and by reference character thereto, there is illustrated in FIG. 1 a device according to the present invention and which device is generally designated by reference numeral 10.

Device 10 comprises an elongated strap 12 formed of a flexible yet sufficiently strong material. Such materials may range from textile products to various types of plastics and combinations thereof. The width of the strap 12 may vary though it has been found that a width of approximately 3 inches is suitable for the use of the same in stacking firewood. At its free end, strap 12 has a hook and loop fastener 14 for reasons which will become apparent hereinbelow.

The strap 12 is preferably wound on a spool generally designated by reference numeral 16 and which spool has a handle 18. The specific type of spool may vary.

In use, the free end of strap 12 having hook and loop fastener 14 is placed about a first log 20 with fastener 14 being attached to a like member. Subsequently, the strap extends below a first row of logs L for a desired length. Subsequently, strap 12 is placed on top of the lower row of logs and extends about the end of the second row of logs as seen in FIG. 2. This arrangement is then repeated for each row of subsequent logs to a desired height.

The arrangement has been found to retain the logs in a neat orderly fashion without the necessity for uprights or the like at the ends.

It will be understood that the above described embodiment is for purposes of illustration only and that changes and modification may be made thereto without departing from the spirit and scope of the invention.

I claim:

1. A method for stacking a plurality of objects comprising the steps of:
supplying an elongated strap having first and second end portions;
securing said first end portion about a first one of said objects;
laying a first portion of said strap along a substrate;
placing a plurality of said objects in a side by side relationship to form a first row;
wrapping said strap about an end of said row on top of said first row;
stacking further objects in a second row on top of said strap placed on said first row; and
wrapping said strap about a second row end object and on top of said second row.

2. The method of claim 1 wherein said plurality of objects comprises pieces of firewood.

3. The method of claim 2 wherein said strap has a length of between 6′ and 50′.

4. The method of claim 3 wherein said strap has a. length of between 10′ and 30′.

5. The method of claim 2 wherein said strap has a length of between 2″ and 8″.

6. The method of claim 5 wherein said strap has a width of between 3″ and 5″.

7. The method of claim 2 wherein said strap is formed of a woven material.

8. The method of claim 2 wherein the strap is dispensed from a spool.

9. A stacked pile of firewood comprising a plurality of rows of stacked firewood, each row having a first and a second end piece, a strap extending from a first end piece of a bottom row under said bottom row and subsequently partially around a second end piece of said bottom row, said strap subsequently extending on top of said second row and partially around a first end piece of a second row, said strap extending back and forth between each row and around end pieces.
